(19) United States
(12) Patent Application Publication
(10) Pub. No.: US 2011/0206885 A1
(43) Pub. Date: Aug. 25, 2011

(54) ENVIRONMENTALLY FRIENDLY INDICIA BEARING SUBSTRATES AND METHOD FOR PRODUCING SAME

(76) Inventor: Christopher Baird Corlett, Glendale, CA (US)

(21) Appl. No.: 13/031,053

(22) Filed: Feb. 18, 2011

Related U.S. Application Data
(60) Provisional application No. 61/305,867, filed on Feb. 18, 2010.

(51) Int. Cl. B44C 1/165; B41F 15/14; B41M 3/12

(52) U.S. Cl. 428/41.7; 101/129; 427/147; 428/195.1; 428/211.1

(57) ABSTRACT

A biodegradable flexible substrate providing a pressure sensitive self adhering transfer marking. The substrate includes a biodegradable paper liner supporting a biodegradable transfer matrix in the form of an ink matrix bearing a transfer marking, a layer of biodegradable clear adhesive over the ink matrix, and a biodegradable protective paper layer over the adhesive layer. The biodegradable ink matrix includes a layer of biodegradable water based clear ink, a layer of biodegradable colored water based inks depicting graphics, and a layer of biodegradable clear protective ink. In another aspect, a process for producing the substrate, is initiated by laying down a heavy clear water based ink or paint on a release liner, then the colors necessary for the graphic design are screen printed on the clear base and a top clear is added.

### CROSS-REFERENCE TO RELATED APPLICATION

This application claims priority of U.S. Provisional Patent Application Ser. No. 61/305,867 filed on Feb. 18, 2010, which is fully incorporated by reference herein as if fully set forth herein. All publications noted in the present application are incorporated by reference herein as if fully set forth herein.

### BACKGROUND OF THE INVENTION

1. Field of The Invention

The present invention relates to substrates, in particular flexible film substrates bearing graphics, and more particularly pressure sensitive self adhering decals, and method and system for producing same.

2. Description of Related Art

Existing pressure sensitive decals are produced by printing on a film that is coated with an adhesive and attached to a release liner. When the decals reach the end of their useful life, they end up in landfills. Likewise the release liners are typically made with silicone and are not easily degradable and they too end up in landfills. If PVC (Poly Vinyl Chloride) or MYLAR (Polyester) films are used, they stay in a landfill forever. Using water based inks on a Mylar or PVC substrates requires a second sheet of plastic called an over laminate to protect the ink from easily being removed. For that reason, solvent based inks are typically used in conjunction with PVC and/or MYLAR constructed decals. Neither option, water based inks and two-piece plastic construction (carrier and over laminate) or solvent or UV (Ultra Violet) based inks, is environmentally friendly. Current pressure sensitive decals also require the use of a die to form irregular shapes after printing, which necessitates an extra production step.

Current technology using a film carrier for the final transfer marking, which produces a heavier decal with higher shipping cost, higher energy consumption and a heavy carbon footprint. This has remained essentially the same for over 40 years. The use of solvent based inks for adhesion to a film carrier releases quantities of VOCs (Volatile Organic Compounds) into the atmosphere. Mounting current pressure sensitive decals can also be a challenge since PVC and Mylar films tend to trap large bubbles which must be popped for proper adhesion.

There remains a need for more efficient and environmentally friendly decals.

### SUMMARY OF THE INVENTION

The present invention is directed to a flexible substrate that provides a transfer marking, which overcomes the drawbacks of the prior art, by adopting biodegradable or substantially biodegradable materials (over at least 95% biodegradable) in its overall structure.

In one aspect of the present invention, the substrate is a pressure sensitive, self adhering flexible sheet (e.g., a film), comprising a biodegradable paper liner supporting a biodegradable transfer matrix, which could be in the form of an ink matrix or web defining a transfer marking (e.g., that depicts a graphic image).

In one embodiment, the biodegradable ink matrix comprises a layer of biodegradable (e.g., water based) clear ink, a layer of one or more biodegradable colored (e.g., water based) inks depicting graphics, and a layer of biodegradable clear protective ink (e.g., a water base) over the graphics. A layer of biodegradable clear adhesive may be provided over the ink matrix to facilitate adhering of the ink matrix onto a mounting surface. The adhesive may also be water based. A biodegradable protective paper liner may be provided over the adhesive layer, to protect the graphics and preserve the adhesive until the ink matrix is applied to a mounting surface.

In another aspect of the present invention, a process for producing the inventive substrate is provided. By printing the marking, graphic design on a paper carrier that is biodegradable, ingestible and environmentally friendly, the process of manufacturing the decal starts with minimal environmental impact. The process initiates by laying down a heavy clear water based ink or paint on a release liner, then the colors necessary for the graphic design are printed on the clear base and a top clear is added. This produces a tough, thin and durable matrix that is environmentally friendly, when low impact water based pressure sensitive adhesive and a paper liner are added, completing the substrate. The matrix has the advantage of looking like it was painted directly on to the surface it is transferred to since there is no paper or plastic carrier to disrupt the image in the final transfer marking The water based ink matrix eliminates the need for a film carrier or film over laminate in the final matrix for the transfer marking, which are otherwise not biodegradable.

In one embodiment, the inventive process comprises the steps of: providing a biodegradable paper liner, screen printing a water based clear-ink to the biodegradable paper liner, printing one or more colored water based inks to produce graphics, printing a clear protective ink over the graphics, screen printing a water based clear protective coat to complete the matrix, printing a clear adhesive then cutting to size and applying a biodegradable paper to protect the marking during application.

By lowering the consumption of material, energy, solvents, VOCs, etc., the carbon impact of the pressure sensitive marking system lowers the impact on the environment by a large factor. By printing the marking on a biodegradable paper liner, the present invention eliminates the need for a film carrier or a film over-laminate in the final matrix for the transfer marking, which are otherwise not biodegradable.

These and other features, aspects and advantages of the present invention, will become better understood with reference to the following drawings, description and claims.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a partially exposed view, illustrating the layers in a decal, in accordance with one embodiment of the present invention.

FIG. 2 is a sectional view of the decal, taken along line 2-2 in FIG. 1.

FIG. 3 is a schematic representation of deployment of a decal on a mounting surface at a commercial establishment, in accordance with one embodiment of the present invention.

### DETAILED DESCRIPTION OF THE INVENTION

The present description is of the best presently contemplated mode of carrying out the invention. This invention has been described herein in reference to various embodiments and drawings. This description is made for the purpose of illustrating the general principles of the invention and should not be taken in a limiting sense. It will be appreciated by those skilled in the art that variations and improvements may be accomplished in view of these teachings without deviating from the scope and spirit of the invention. The scope of the invention is best determined by reference to the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention is directed to a flexible substrate that adopts biodegradable materials in its overall structure, which provides a transfer marking. In the context of the present invention, in one embodiment, a biodegradable material is one that is at least substantially biodegradable, or at least 95% biodegradable. In another embodiment, a biodegradable material is one that is at least 98% biodegradable. In one aspect of the present invention, the substrate is a pressure sensitive, self adhering flexible sheet (e.g., a film), comprising a biodegradable paper liner supporting a biodegradable transfer matrix in the form of an ink matrix or web (e.g., that depicts a graphic image) bearing a transfer marking.

Broadly, an embodiment of the present invention generally includes a method and system of producing a self adhering pressure sensitive marking decal that eliminates the need for a carrier film and a clear plastic over laminate in the final matrix for the transfer marking. This method and system reduces material consumption, energy use, shipping weight, VOC's, solvents, landfill bulk and it is biodegradable. The process for producing pressure sensitive decal requires only a straight forward screen printing onto a support substrate. The decal in accordance with the present invention requires a totally new approach to produce the water based matrix that becomes the transfer medium.

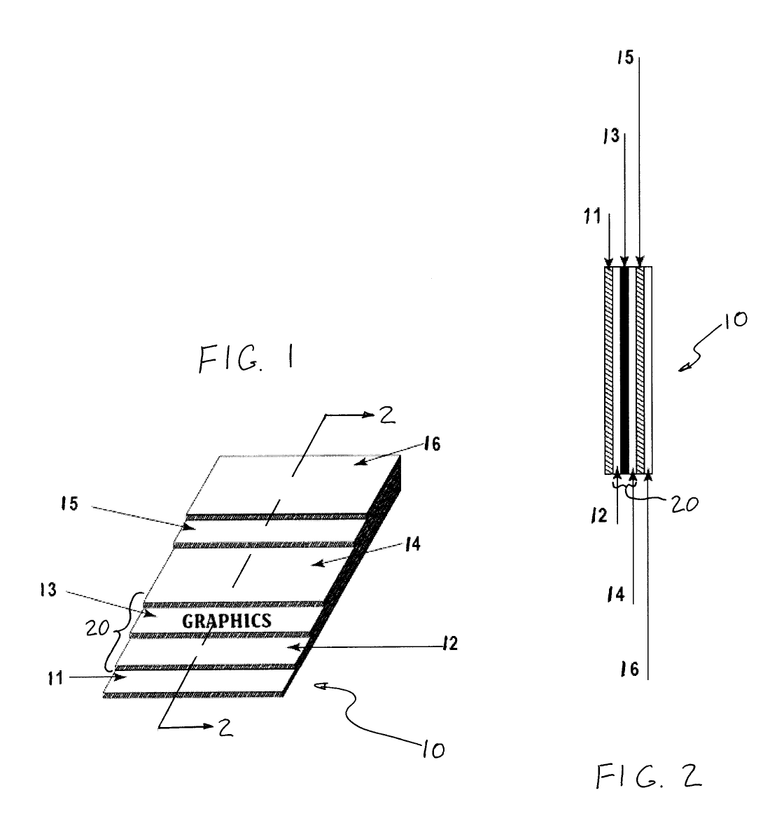

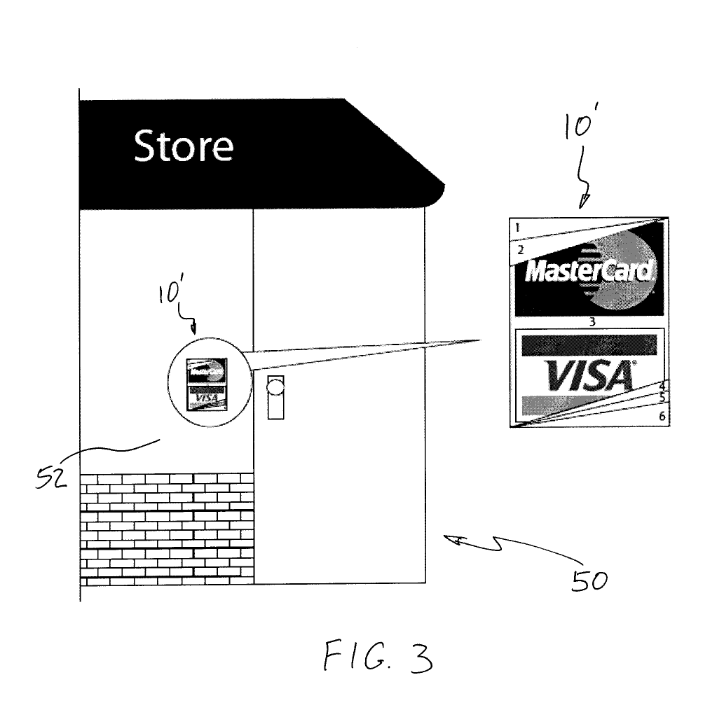

The present invention will be further described below in connection with the illustrated embodiments directed to decals (which may include labels, seals, tags, etc). Referring to FIGS. 1 and 2, one embodiment of the inventive decal 10 comprises a biodegradable paper liner 11 (e.g., an inert, ingestible, biodegradable paper liner) supporting a biodegradable ink matrix or web 20 that depicts a graphic image. The biodegradable ink matrix 20 comprises a layer 12 of water based clear ink, a layer 13 of one or more colored water based inks depicting a marking such as graphics, and a layer 14 of a water based clear ink as a protective coat over the graphics. In this embodiment, the various layers within the ink matrix 20 are made of a biodegradable material (e.g., biodegradable inks) It is within the scope and spirit of the present invention that the clear layer 12 and/or clear layer 14 could include a clear color tint. The colored layer 13 comprises opaque or translucent color(s) to render the desired marking The entire ink matrix 20 will generally run less than 0.001 (1 mil) in thickness, according to one embodiment of the present invention.

To facilitate adhering of the ink matrix 20 onto a mounting surface, a layer 15 of a water based clear adhesive is provided over the ink matrix 20. To protect the graphics and preserve the adhesive layer 15 until the ink matrix 20 is applied to a mounting surface, a biodegradable protective paper liner 16 is provided over the adhesive layer 15.

It is noted that the graphics depicted by the ink matrix 20 includes multi-color graphics (i.e., a multi-color decal) or single color graphics (a single-color decal). For example, a single color decal may be a single color patch or banner of a particular planar shape.

While the foregoing embodiment comprises specific layers of materials, it is well within the scope and spirit of the present invention to include other intermediate layers, such as buffer or primer layers, and/or stabilizing layers. Further, each layer may include one or more separate coats or sublayers formed by sequential or consecutive steps. For example, the first clear layer 12 may include a combination of separate thin coats of clear inks The colored layer 13 may include separate overlapping coats of various colors.

In another aspect of the present invention, a process for producing the inventive substrate is provided. By printing the marking, graphic design on a paper carrier that is biodegradable, ingestible and environmentally friendly, the process of manufacturing the decal starts with minimal environmental impact. The process initiates by laying down a heavy clear water based ink or paint on a release liner, then the colors necessary for the graphic design are printed on the clear base and a top clear layer is added. This produces a tough, thin and durable matrix that is environmentally friendly, when low impact water based pressure sensitive adhesive and a paper liner are added, completing the substrate. The matrix has the advantage of looking like it was painted directly on to the surface it is transferred to since there is no paper or plastic carrier to disrupt the image of the transfer marking supported by the final matrix. The water based ink matrix eliminates the need for a film carrier or film over laminate in the final matrix, which are otherwise not biodegradable.

In accordance with one embodiment, a process of making the inventive decal 10 comprises the following steps:

a. Starting with an imported paper release liner 11 (e.g., from Tullis Russell Inc. in Fairfield, Conn., USA; www.tullisrussellusa.com) that is inert, ingestible and biodegradable and is designed to easily release ink deposits (i.e., the ink matrix 20).

b. Screen printing the layer 12 of clear water based ink using a large mesh screen to allow for the required deposit. The screen mesh can vary from 75 to 200 depending on environmental conditions, size of the decal and graphics. The inks used are off-the-shelf water based systems (e.g., from T.W. Graphics and Nazdar). Prior to printing, they may need to be modified to produce the desired result. For example, modifications may be made on press by printers based on skills in the printing art. For example, thinners (preferably of biodegradable grade) are added to the ink, by an amount that depends greatly on environmental conditions, temperature, humidity, etc. A 1½% to 3% of a hardener (preferably of biodegradable grade) may be added to the ink to provide the strength necessary to allow the matrix to function as a transfer medium. Such modifications are well within the skills of one skill in the art.

c. Screen printing the colors necessary to produce the layer 13 depicting the graphics; the printing procedure changes, not only to allow for reproduction of fine details but also to add to the overall strength and flexibility of the ink matrix 20. Generally, the screen mesh used will run from 260 to 305. When printing colors, the thinner used has to be carefully controlled to avoid impact on the matched colors being printed. When printing the colors, the original art has already been modified to allow for more overlap and larger traps than normally required for current pressure sensitive decals.

d. Screen printing the last water based clear layer 14 that encapsulates and ties all of the ink layers into a strong flexible matrix. The procedure is the same as laying down the first clear layer 12. This final clear layer 14 completes the ink matrix 20.

e. Printing by applying a screened water based adhesive to form adhesive layer 15. This adhesive can be varied depending on the aggressiveness the decal user requires and the target application or mounting surface on which the ink matrix 20 of the decal 10 will be applied.

f. Applying a paper liner 16 to protect the adhesive until the decal is installed. The paper release liner is also imported from Tullis Russell, Inc., and is inert, ingestible and biodegradable. As may be required, the release liner 16 can be printed (image printing) with instructions for use or advertising copy.

The overall thickness of the ink matrix 20 may be about 1 mil thick, with the first clear layer being 0.25 mil to 0.5 mil thick, depending on the thickness of the colored layer 13 required.

While the foregoing embodiment comprises specific printing steps, it is well within the scope and spirit of the present invention to include other intermediate printing or layering steps for other intermediate layers, such as buffer or primer layers, and/or stabilizing layers. Further, printing for a layer may include one or more separate sequential or consecutive printing steps to produce coats or sublayers to form the overall layer. For example, the first clear layer 12 may include a combination of separate thin coats of clear inks formed by separate printing steps. The colored layer 13 may include separate overlapping coats of various colors formed by separate printing steps.

As described above, the preferred printing method is screen printing using water based inks and adhesives. This allows better control of the thickness, strength, color and other aspects of the matrix necessary to produce a high quality pressure sensitive decal. The water based inks used are formulated with the amount of pigment use often leaning toward the paint end of the scale. (It is noted that the paint industry often refers to ink and paint interchangeably, although the paint industry sometimes refers to “Ink” as a pigmented liquid or paste used especially for writing or printing, and “Paint” as a liquid mixture usually of solid pigment in a liquid vehicle. Accordingly, references to water based ink herein also include water based paint.) It is important to control the liquid used for printing, since the marking, when applied, consists only of water based inks and adhesives in a matrix.

Irregular outlines and shapes are a byproduct of the printing process and require no hard tooling or secondary processing to obtain the required outline shape of the graphics to be transferred using the ink matrix 20. This reduces production steps, which also reduces waste of materials in the manufacturing process. Because the ink transfer matrix is very thin (e.g., 1 mil thick), it allows the matrix to easily follow irregular surfaces without trapping air. The marking cannot be removed from its application surface without destroying the graphics, which makes it a good tamper proof seal.

In another embodiment, this system also allows for the production of double faced pressure sensitive decals for application to windows, allowing the graphics to be viewed from both sides. The colors necessary for the graphics are printed face down. Then by printing white-silver-white, the graphics are repeated face up before the final clear and adhesive are printed.

Various applications of the inventive substrate or “decal” may be realized. Applications include all existing pressure sensitive marking (decal, sticker) applications. Additional applications are safety seals, security seals, bank decals, stickers, promotional decals, and the like. Specific examples of security applications and tamper proof and security seals include: overseas shipping container seals, electric box seal, anti-counterfeiting seals for venue tickets and other media, retail window decals, tax seals, product identification, corporate logos, advertising decals, shipping labels, produce identification, inventory labels, inspection labels, instruction labels, warning labels, promotional decals, name tags, credit card accepted decal, etc. Once a tamper proof seal or decal is mounted onto a clean dry surface it cannot be removed and replaced without destroying the graphics (image). This makes it effective for sealing shipping containers, rail cars, trucks, etc., providing a low cost, easy implementation, practical way to make sure the doors have not been opened.

The inventive pressure sensitive decals can be applied to any clean dry surface by removing the paper liner 16 that protects the adhesive 15, then applying the adhesive side of the matrix 20 to the areas to be marked. Once in the correct place, rub the back of the release liner 11 with fingers, a credit card or a squeegee, and remove the release liner 11 protecting the graphics. FIG. 3 schematically illustrates an application of the inventive decal 10, in particular a “credit card accepted” decal 10′ applied to the door or window 52 of a commercial establishment 50. To apply the decal 10′, the protective paper layer 16 is removed and the adhesive layer 15 is pressed against a clean dry section of the window 52. Depending the direction of printing of the graphics, the decal 10′ may be applied to the outside or inside surface of the window 52, to provide the desired view. For double sided printing, both the adhesive side and the release liner side of the matrix are printed to show desired graphics. After the decal 10′ is applied to the window 52, the release liner 11 is removed, leaving the ink matrix 20 (including the first clear layers 12, the colored layer 13 and the second clear layer 14) on the window, bearing the graphics.

Based on accelerated weather testing of an applied decal 10 in a typical outdoor application, it has been shown that the ink matrix has durability well in excess of 5 years. It has been found that once the decal is mounted to a clean dry surface, it is very difficult to remove without using isopropyl alcohol. It has also been found that it was impossible to remove and replace the decal without destroying the graphics.

The advantages of the present invention over the prior art can readily be appreciated. By printing the marking, graphic design on a paper carrier that is biodegradable, ingestible and environmentally friendly, the process of manufacturing the decal starts with minimal environmental impact. The top protective paper is also completely biodegradable. By lowering the consumption of material, energy, solvents, VOCs, etc., the inventive pressure sensitive marking system lowers the impact on the environment by a large factor. By printing the marking on a biodegradable paper liner, the present invention eliminates the need for a film carrier or a film over-laminate in the matrix in the final matrix, which are otherwise not biodegradable. The present invention relates to a new method of producing pressure sensitive markings that are eco-friendly, tamper proof, cost effective to manufacture and easy to install. This system eliminates the need for poly-vinyl chloride (PVC) and/or polyester (Mylar) carriers widely used in the production of decals heretofore, also commonly referred to as stickers. The present invention does not require the use of solvent based inks and/or solvent based adhesives, both of which are widely used in the industry. None of these materials are environmentally friendly in any way. In particular, PVC and MYLAR take up an enormous amount of landfill space while virtually never degrading and they contain phthalates and other carcinogenic compounds. Because the transfer matrix in accordance with the present invention is designed around the absence of a paper or film based transfer material, it provides for a very cost effective product that is still easily installed, tamper proof, and environmentally friendly. Some of the advantages and unexpected results achievable by the present invention are further elaborated below.

The method and system of the present invention eliminates the need for a paper or plastic film (carrier) transfer matrix for solvent inks and adhesives used to produce current pressure sensitive (self adhering) markings Since the water based inks and adhesives used do not have to adhere to a carrier to form the transfer matrix, the need for any clear plastic over laminate to protect the image is also eliminated. This lowers the consumption of non-biodegradable materials and eliminates the need for solvent based inks and adhesives.

The present invention allows the production of high quality pressure sensitive markings, which are cost effective to manufacture and at the same time lowers impact on landfills and carbon footprint. By using water based inks and adhesives, the marking is nearly inert and will almost completely degrade in a landfill. Material consumption is also lowered since irregular outline can be produced without the need for hard tooling or a cutting step.

The present method and system for producing the inventive decal includes the following steps: cutting 100% biodegradable paper carrier to size, screen printing water based clear protective layer. Printing one or more colored water based inks to produce the required graphics, printing a clear protective adhesive, and cutting to size and applying a biodegradable liner to protect the marking during application.

Pressure sensitive markings produced by the present invention cannot be removed and replaced from a smooth clean dry surface without being destroyed. The printed graphics are not meant to be removed without destroying the graphics, thereby providing the perfect tamper proof seal for use on shipping containers or any other product that is not to be opened without authorization.

The present method and system eliminates the need for a paper or plastic carrier (film) transfer matrix for the marking and the need for solvent based ink and adhesives and non-biodegradable liners. The present invention can produce a pressure sensitive marking that eliminates the need for a plastic or paper film to carry a printed image. A better pressure sensitive marking can be produced which significantly reduces or eliminates the large non-biodegradable portion of current pressure sensitive markings. By using water based inks and adhesive only in the production of the marking, the present invention lowers the carbon foot-print. By eliminating the need for a clear over-laminating film in the final matrix bearing the transfer marking (which is needed in the prior art to insure adhesion) the present invention lowers the impact on land-fills and material consumption.

The present invention provides for pressure sensitive marking that lowers consumption of materials and energy by a large factor. The present invention can produce pressure sensitive markings that are easy to mount onto a clean surface and impossible to remove without destroying the graphic image, which makes it the perfect tamper proof seal. The pressure sensitive marking allows for the production of irregular outlines without hard tooling or additional production steps to obtain the irregular outlines, which reduces waste of materials. The present invention reduces material consumption, allows for production of high quality pressure sensitive marking in a very cost effective manner with a much lower environment impact than current technology.

It will be apparent to those skilled in the art that various modifications and variations can be made to the disclosed structures and processes of the present invention without departing from the scope or spirit of the invention. In view of the foregoing descriptions, it is intended that the present invention covers modifications and variations of this invention if they fall within the scope of the following claims and their equivalents.

What is claimed is:

1. A flexible substrate providing a transfer marking, comprising:
a biodegradable release liner; and
a biodegradable transfer matrix supported on the release liner, which depicts a desired marking to be transferred to a mounting surface.

2. A flexible substrate as in claim 1, wherein the transfer matrix comprises a first clear layer above the release liner, a colored layer above the first clear layer depicting the desired marking, and a second clear layer above the colored layer.

3. A flexible substrate as in claim 2, wherein the first clear layer, the colored layer and the second clear layer comprise water based inks

4. A flexible substrate as in claim 3, wherein the water based inks comprise biodegradable inks

5. A flexible substrate as in claim 4, wherein the release liner comprises a biodegradable paper.

6. A flexible substrate as in claim 3, wherein the first clear layer, the colored layer and the second clear layer are formed above the release liner by printing.

7. A flexible substrate as in claim 1, further comprising an adhesive layer above the second clear layer, and a protective liner above the adhesive layer.

8. A flexible substrate as in claim 7, wherein the adhesive layer comprises a biodegradable adhesive material and the protective liner comprise a biodegradable paper.

9. A method for producing a flexible substrate that provides a transfer marking, comprising:
providing a biodegradable release liner; and
providing a biodegradable transfer matrix supported on the release liner, which depicts a desired marking to be transferred to a mounting surface.

10. A method as in claim 9, wherein the transfer matrix comprises a first clear layer above the release liner, a colored layer above the first clear layer depicting the desired marking, and a second clear layer above the colored layer.

11. A flexible substrate as in claim 10, wherein the first clear layer, the colored layer and the second clear layer comprise water based inks.

12. A flexible substrate as in claim 11, wherein the water based inks comprise biodegradable inks.

13. A flexible substrate as in claim 12, wherein the release liner comprises a biodegradable paper.

14. A flexible substrate as in claim 11, wherein the first clear layer, the colored layer and the second clear layer are formed above the release liner by printing.

15. A flexible substrate as in claim 9, further comprising an adhesive layer above the second clear layer, and a protective liner above the adhesive layer.

16. A flexible substrate as in claim 15, wherein the adhesive layer comprises a biodegradable adhesive material and the protective liner comprise a biodegradable paper.

17. A method for producing a flexible substrate that provides a transfer marking, comprising:
providing a biodegradable paper release liner;
printing onto the paper liner, a first water based clear ink layer;
printing onto the first water based clear ink, one or more colored water based inks to produce graphics;
printing over the graphics a second water based clear ink layer;
printing on the second water based ink, a water based adhesive; and
providing a biodegradable protective liner over the adhesive.

18. A method as in claim 17, wherein the first water based clear ink layer, the second water based clear ink layer and the colored water based inks comprise biodegradable materials.

19. A method as in claim 18, wherein at least printing of the colored water based inks comprise screen printing.

20. A method as in claim 19, wherein printing of the first water based clear ink and the second water based clear ink layer comprises screen printing.
